(19) United States
(12) Patent Application Publication
(10) Pub. No.: US 2025/0367582 A1
(43) Pub. Date: Dec. 4, 2025

(54) FILTER DEVICE

(71) Applicant: YAMASHIN-FILTER CORP., Kanagawa (JP)

(72) Inventors: Nobuyuki Kitajima, Kanagawa (JP); Naoki Numakura, Kanagawa (JP); Nobuki Sasaki, Kanagawa (JP); Masanori Wakabayashi, Kanagawa (JP)

(21) Appl. No.: 19/300,735

(22) Filed: Aug. 15, 2025

Related U.S. Application Data
(63) Continuation of application No. PCT/JP2023/047068, filed on Dec. 27, 2023.

(30) Foreign Application Priority Data
Feb. 22, 2023 (JP) 2023-026774

(51) Int. Cl. B01D 35/143; B01D 29/21; B01D 29/60; B01D 35/30

(52) U.S. Cl. CPC B01D 35/143; B01D 29/21; B01D 29/606; B01D 29/608; B01D 35/30; B01D 2201/0453; B01D 2201/12; B01D 2201/52; B01D 2201/56

(57) ABSTRACT

A filter device includes: a filter element including a filtration member configured to filter a liquid and an IC tag including a first antenna coil; a filter case in which the filter element is installed; and a measurement unit installed in the filter case and including an antenna including a second antenna coil. The filter device performs transmission by magnetic resonance coupling between the first antenna coil and the second antenna coil. The filter case includes a partition wall that partitions an internal space into a first region provided with the filter element and a second region not provided with the filter element and is made of metal. The measurement unit includes a housing attached to the filter case. While the housing is disposed in the filter case, a tip end of the housing is inserted in the second region.

### CROSS-REFERENCE TO RELATED APPLICATIONS

This application is a continuation application of International Patent Application No. PCT/JP2023/047068 filed on Dec. 27, 2023, which claims priority to Japanese Patent Application No. 2023-026774 filed on Feb. 22, 2023, the entire contents of which are incorporated by reference.

### TECHNICAL FIELD

The present invention relates to a filter device.

### BACKGROUND ART

Patent Document 1 discloses a filter system that performs wireless power transmission. In this filter system, a wireless power receiver is associated with a filter body, and the wireless power receiver includes a feedback channel circuit. The feedback channel circuit includes a receiving antenna and a control circuit electrically communicating with the wireless power receiver, communicates with the control circuit, and is configured to transmit via a channel separated from a receiving antenna.

### CITATION LIST

### Patent Literature

Patent Document 1: JP 2021-512778 A

In a filter device, an IC tag storing various information is disposed inside a filter element (i.e., a metal housing), and various management is performed by acquiring information from the IC tag. However, the related technologies, including the invention described in Patent Document 1, do not allow wireless transmission when the housing is a metal such as stainless steel. Thus, it has been common practice to install slits or the like in a portion of the housing in order to provide wireless transmission beyond the metal housing.

However, providing extra slits or the like in the housing can cause problems such as housing failure due to stress fatigue. This also reduces the degree of freedom of housing design.

### SUMMARY OF INVENTION

One or more aspects of the present invention provide a filter device capable of performing wireless transmission across metal.

A filter device according to one or more aspects of the present invention includes: for example, a filter element including a filtration member configured to filter a liquid and an IC tag, including a first antenna coil; a filter case provided with the filter element inside; and a measurement unit disposed in the filter case and including an antenna including a second antenna coil. The filter device performs transmission by magnetic resonance coupling between the first antenna coil and the second antenna coil. The filter case includes a partition wall that partitions an internal space into a first region provided with the filter element and a second region not provided with the filter element and is made of metal. The measurement unit includes a housing disposed in the filter case. While the housing is disposed in the filter case, a tip end of the housing is inserted in the second region. The antenna and the IC tag are positioned across the partition wall.

The filter device according to one or more aspects of the present invention provides the antenna and the IC tag across a metal partition wall and performs transmission by magnetic resonance coupling between the first antenna coil of the IC tag and the second antenna coil of the antenna. This allows for wireless transmission across metal.

The measurement unit may include a sensor configured to measure viscosity or temperature of the liquid. The housing may include an insert portion to be inserted into the filter case or the second region. The antenna may be disposed near a tip end of the insert portion. The sensor may be disposed inside a hollow portion formed in the insert portion. The housing may be provided with a communication hole through which the hollow portion communicates with a space outside the housing. This allows the liquid to be monitored.

The filter element may include an upper plate that covers an upper end surface of the filtration member. The IC tag may have an annular shape and may be disposed at the upper plate. The first antenna coil may be wound along an inner peripheral surface or an outer peripheral surface of the IC tag. This can make a first antenna coil larger and increase efficiency of wireless transmission.

The measurement unit may further include a differential pressure detection unit configured to detect differential pressure between pressure upstream of the filtration member and pressure downstream of the filtration member. This allows the measurement unit to incorporate multiple functions and save space.

The present invention according to one or more aspects allows wireless transmission to be performed across metal.

### BRIEF DESCRIPTION OF DRAWINGS

FIG. 1 is a perspective view schematically illustrating a filter device 1.

FIG. 2 is a cross-sectional perspective view schematically illustrating the filter device 1.

FIG. 3 is a cross-sectional perspective view schematically illustrating the filter device 1 of which a main portion is enlarged.

FIG. 4 is a block diagram illustrating the electrical configuration of a wireless transmission unit 50.

FIG. 5 is a diagram illustrating an example of resonance circuits 54a and 51b. (A) illustrates a schematic of an SS topology, and (B) illustrates a schematic of an SP topology.

### DESCRIPTION OF EMBODIMENTS

Embodiments of the present invention will be described below in detail with reference to the drawings. A filter device removes dust or the like from the liquid such as oil, fuel, urea water. In the present embodiments, a hydraulic oil line filter that removes dust or the like contained in the hydraulic oil will be described as a filtration device, but filtration devices are not limited to hydraulic oil line filters and can also be used for return filters and fuel filters, for example. In the present embodiments, hydraulic oil (mineral-based) is used as the liquid to be filtered, which is not limited to the hydraulic oil but can be various liquids including additives, e.g., fuels (petroleum-based, ethanol-based, or the like).

### First Embodiment

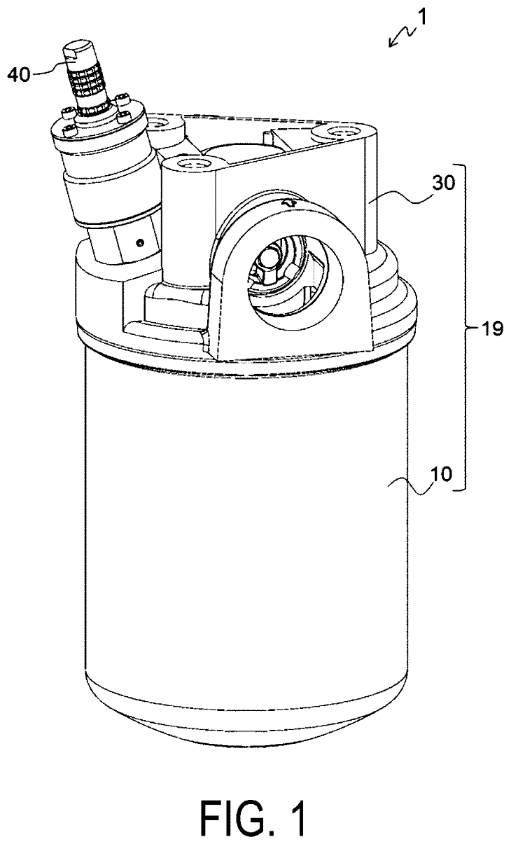

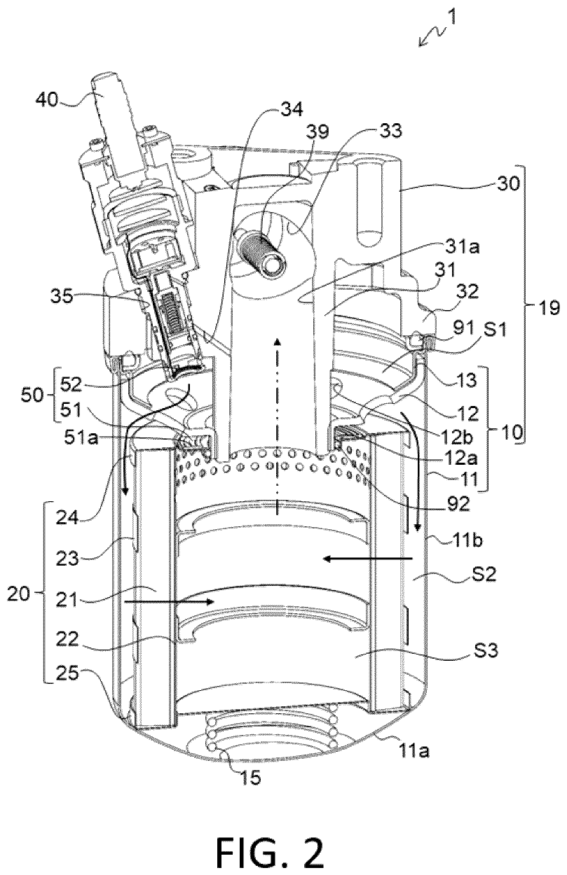

FIG. 1 is a perspective view schematically illustrating the filter device 1. FIG. 2 is a cross-sectional perspective view schematically illustrating the filter device 1. The hatching illustrating the cross section is omitted in FIG. 2.

The filter device 1 mainly includes a filter case 19, a filter element 20, a measurement unit 40, and the wireless transmission unit 50. The measurement unit 40 is used while attached to the filter device 1. The wireless transmission unit 50 includes an IC tag 51 installed in the filter element 20 and an antenna 52 installed in the measurement unit 40. The transmission by magnetic resonance coupling is performed between an antenna coil 51a of the IC tag 51 (described in detail below) and an antenna coil 52a of the antenna 52 (described in detail below).

The filter case 19 includes a case 10 and a head 30. The case 10 and the head 30 are each formed of corrosion-resistant metal.

A case 10 mainly includes a case body 11 and a partition wall 12. The case body 11 has a bottomed cylinder shape with an opening at the top end. The case body 11 is hollow inside, and the head 30 is provided to cover the opening at the top end.

The partition wall 12 is provided to cover the opening in the upper end surface of the case body 11. Thus, the partition wall 12 divides the internal space of the filter case 19, in which the head 30 is attached via the case body 11, into two regions: one region (the first region of the present invention, i.e., a space S2 and S3) provided with the filter element 20, and the other region (the second region of the present invention, i.e., spaces S1) not provided with the filter element 20.

The partition wall 12 is installed in the case body 11 by means of an attachment portion 13 provided in the case body 11, but the method of attachment of the partition wall 12 is not limited to this. The partition wall 12 only needs to be provided in the filter case 19, and may be provided in the head 30, for example.

The partition wall 12 includes a tubular portion 12a, and the filter element 20 is inserted in the tubular portion 12a. The tubular portion 12a and the filter element 20 are sealed by a sealing member (e.g., O-ring) 92. Between a bottom surface 11a of a case body 11 and the filter element 20, an elastic member 15 such as a coil spring is provided. The elastic member 15 presses the filter element 20 toward the tubular portion 12a. As a result, the filter element 20 is installed in the space enclosed by the bottom surface 11a, a side surface 11b and the partition wall 12, of the case body 11.

The filter element 20 mainly includes a filtration member 21, an inner tube 22, an outer tube 23, a plate 24, and a plate 25.

The filtration member 21 is a member that filters the liquid and is a tubular (here, cylindrical) member with the openings at both ends. The filtration member 21 is formed by pleating a filter paper using such as, for example, synthetic resin or a paper, and connecting both ends of the pleated filter paper to form a cylindrical shape. However, the form of the filtration member 21 is not limited to this.

Inside the filtration member 21 is the inner tube 22 with holes for the fuel to pass through over the substantially entire area. A strip-shaped outer tube 23 is provided outside the filtration member 21. The inner tube 22 and the outer tube 23 are not essential.

At the upper end of the filtration member 21, the plate 24 (corresponding to the upper plate of the present invention) is provided. The plate 24 covers the upper end surfaces of the filtration member 21 and the inner tube 22. The plate 24 and the filtration member 21 are bonded by an adhesive. Adhesives can be various types of organic adhesives, mainly made of resin, rubber, or elastomer.

The filtration member 21 is located below the plate 24. The IC tag 51 is also provided above the plate 24. In other words, IC tag 51 is located near the partition wall 12.

The IC tag 51 is a small electronic component that can communicate with the antenna 52 (described in detail below) and read/write data in the built-in memory in a non-contact manner using wireless waves received from the antenna 52.

The IC tag 51 is circular and concentric with the plate 24. The IC tag 51 includes the antenna coil 51a (corresponding to a first antenna coil of the present invention). The antenna coil 51a is wound along the inner or outer surface of the IC tag 51. The IC tag 51 also includes a modulation circuit.

The arrangement of the IC tag 51 in the plate 24 is not limited to this. For example, when the plate 24 is made of resin, the IC tag 51 may be provided inside the plate 24 by insert molding or the like.

At the lower end of the filtration member 21, the plate 25 is provided. The plate 25 covers the lower end surfaces of the filtration member 21 and the inner tube 22. The filtration member 21 is located above the plate 25. The plate 25 and the filtration member 21 are bonded by an adhesive.

The head 30 is provided on the case 10 to cover the upper end surface of the case 10. The case 10 and the head 30 are sealed by a sealing member (e.g., O-ring) 91.

The head 30 includes mainly the tubular portion 31 to be inserted into the tubular portion 12a and an outer peripheral portion 32 to be attached to the case 10. The tubular portion 31 includes a hollow portion 31a that is a part of an outflow portion 33.

When the outer peripheral portion 32 is fixed to the case 10, the tubular portion 31 is inserted into the tubular portion 12a, and the inner space of filter element 20 (space S3) and the outflow portion 33 are communicated. The head 30 includes an inflow portion, not illustrated in the drawing, which allows the hydraulic oil to flow into the space S1 enclosed by the tubular portion 31, the outer peripheral portion 32, and the partition wall 12. A bypass valve 39 is provided between the inflow portion and the outflow portion 33.

The hydraulic oil that flows into the space S1 flows through a hole 12b in the partition wall 12 into the space, which is enclosed by the case body 11 and the partition wall 12 and is outside (space S2) the filter element 20.

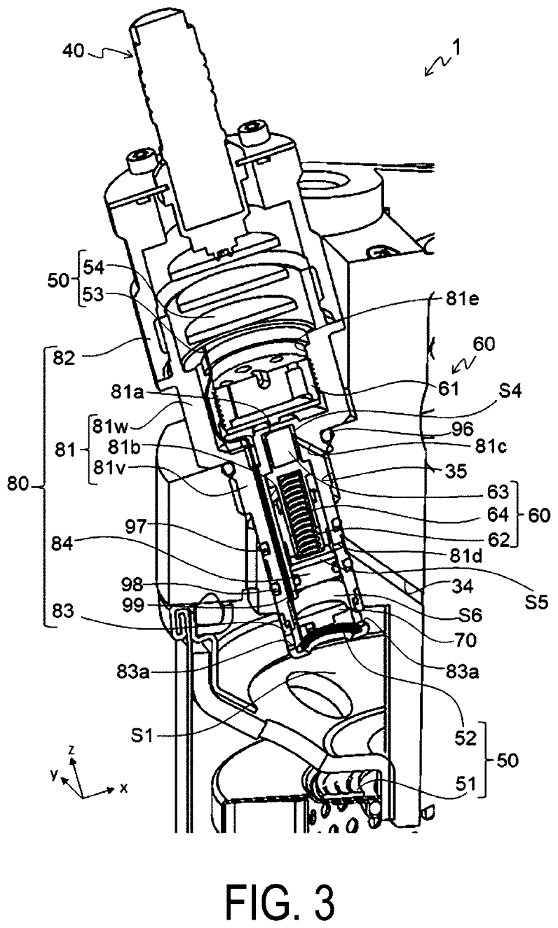

The head 30 includes the measurement unit 40. The measurement unit 40 is described below. FIG. 3 is a cross-sectional perspective view schematically illustrating the filter device 1 of which the main portion is enlarged. In FIG. 3, the hatching illustrating the cross section is omitted.

The measurement unit 40 mainly includes a housing 80, a differential pressure detection unit 60, a sensor unit 70, and the antenna 52. Thus, by incorporating multiple functions in the measurement unit 40, only one measurement unit 40 is needed in the head 30, thereby saving space. Hereafter, the longitudinal direction of the housing 80 is referred to as a z-direction, and the two directions orthogonal to the z-direction are referred to as a x-direction and a y-direction. The x-direction and the y-direction are orthogonal.

The housing 80 mainly includes a case 81, covers 82 and 83, and an insertion member 84. The case 81 includes columnar portions 81v and 81w having a columnar shape to be attached to the filter device 1 (see FIG. 2). A columnar portion 81v is inserted into a hole 35 of the head 30 (see FIG. 2). A columnar portion 81w is in contact with the end face where the hole 35 is provided. The case 81 and the hole 35 are sealed by a plurality of sealing members (e.g., O-rings) 96, 97, and 98.

Covers 82 and 83 each have a bottomed cylindrical shape and are provided at both ends of the case 81, respectively. The cover 82 is provided to cover one end (+z-side) of the case 81, and a cover 83 is provided to cover the other end (−z-side) of the case 81.

The case 81 is provided with a bore 81a and a bore 81b. The differential pressure detection unit 60 and the insertion member 84 are provided in the bores 81a and 81b, respectively. The insertion member 84 is located near the opening of the bore 81b, and the space between the insertion member 84 and the bore 81b is sealed by a sealing member (e.g., O-ring) 99.

In the space enclosed by the bores 81a, 81b and the insertion member 84, the differential pressure detection unit 60 is provided. The differential pressure detection unit 60 mainly includes a detection unit 61, a spool 62, a magnet 63, and an elastic member 64.

The spool 62 is cylindrical and movable in the z-direction inside the bores 81a and 81b. The spool 62 divides the space enclosed by the bores 81a, 81b and the insertion member 84 into a space S4 and a space S5. One end of a hole 81c opens at the space S4. One end of a hole 81d opens at the space S5.

The elastic member 64 is, for example, a coil spring, one end of which is provided in the spool 62 and the other end on the bottom surface of the bore 81b. The elastic member 64 exerts a force in the +z-direction on the spool 62. The magnet 63 is provided on the surface opposite to the bottom surface of the bore 81a of the spool 62.

The detection unit 61 is provided inside a bore 81e. The detection unit 61 is adjustable in the z-direction.

The detection unit 61 includes a magnetic field detection element (not illustrated). The magnetic field detection element detects changes in the magnetic field formed by the magnet 63. The magnetic field detection element can be a reed switch, a Hall element, or the like. The detection results of the magnetic field detection element are output to the outside of the measurement unit 40 via a signal line not illustrated. A reed switch and a Hall element are already well known, and their description is omitted.

The holes 81c and 81d each penetrate the side surface of the columnar portion 81v in the radial direction (here, in the x-direction), and the other ends of the holes 81c and 81d each open in the outer surface of the columnar portion 81v. As a result, the hole 81c communicates the hole 35, that is, the space S1 (see FIG. 2), with the space S4, and the hole 81d communicates the space S3 (see FIG. 2) with the space S5 via a bore 34. As a result, the pressure difference between the space S1 and the space S3 causes the spool 62 and the magnet 63 to move in the z-direction, and thus the pressure difference between the upstream and downstream sides of filtration member 21 can be detected.

The cover 83 is provided at the tip of the columnar portion 81v. The columnar portion 81v and the cover 83 correspond to the insert portion of the present invention. The space formed by the inner space of the cover 83 and the space formed by the insertion member 84 and the bore 81b (space S6, corresponding to the hollow portion of the present invention) includes the antenna 52 and the sensor unit 70.

The antenna 52 is provided on the bottom surface of the cover 83, that is, near the tip of the insert portion of the present invention. However, the location of the antenna 52 is not limited to this location. In short, the antenna 52 and the IC tag 51 only need to be provided across the partition wall 12.

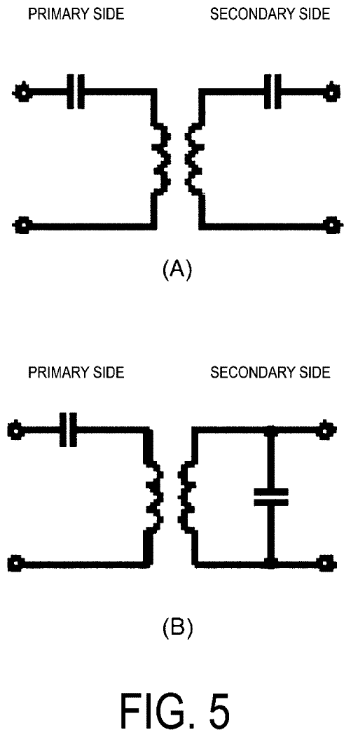

The antenna 52 also includes a wiring pattern (including antenna coil 52a, which corresponds to the second antenna coil of the present invention, see FIG. 5) formed on one side (e.g., the side facing the cover 83) of the antenna 52. In FIG. 3, illustration of the wiring pattern is omitted.

An antenna line 53 is connected to the antenna coil at one end and to a substrate 54 at the other end. IC chip or the like (not illustrated in the drawing), is mounted on the substrate 54. When a wireless wave from the IC tag 51 is received, a reception signal is generated at the substrate 54 via the antenna line, and that signal is output to the outside of the measurement unit 40 via a signal line not illustrated.

The sensor unit 70 is located on the root side of the case 81 (columnar portions 81v, 81w) rather than the antenna 52. The sensor unit 70 includes, as sensors, a temperature sensor to measure the temperature of the liquid and a viscosity sensor to measure the viscosity of the liquid. The hydraulic oil is supplied to the space S6 via a hole 83a (corresponding to the communication hole of the present invention) of the cover 83, allowing the sensor unit 70 to accurately measure the temperature and viscosity of the hydraulic oil. The measurement result at a temperature sensor 71 and a viscosity sensor 72 are also communicated to the substrate 54. However, the sensor unit 70 is not limited to this, and needs only to include a temperature sensor or a viscosity sensor.

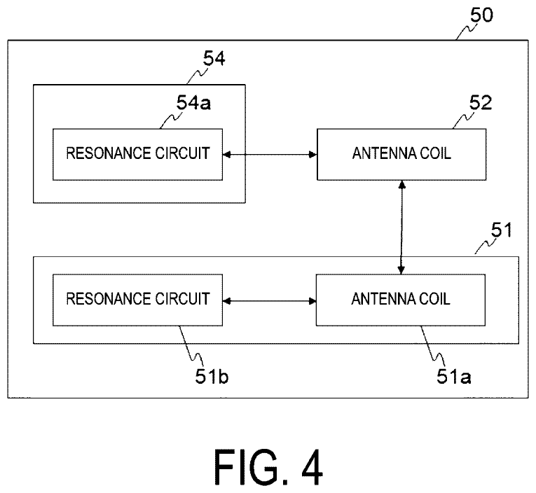

FIG. 4 is a block diagram illustrating the electrical configuration of the wireless transmission unit 50. The IC tag 51 includes the antenna coil 51a and a resonance circuit 51b connected to the antenna coil 51a. The antenna 52 includes the antenna coil 52a, and the substrate 54 includes the resonance circuit 54a. The antenna coil 52a is connected to the resonance circuit 54a.

FIG. 5 illustrates an example of the resonance circuit 51b and 54a. FIG. 5(A) illustrates a schematic of a resonance circuit having an SS topology, and FIG. 5(B) illustrates a schematic of a resonance circuit having an SP topology. In the SS topology, each of the primary winding (antenna coil 52a) and the secondary winding (antenna coil 51a) includes a capacitor connected in series. In the SP topology, the primary winding includes a capacitor in series and the secondary winding includes a capacitor in parallel.

For wireless transmission across metal walls using an SP topology, the technology disclosed in, for example, Mai Otsuka, Takehiro Imura, Hiroshi Fujimoto, and Yoichi Hori, “Basic Study on Circuit Topology for High Efficiency Wireless Power Transfer through Metal Wall” (The Institute of Electronics, Information and Communication Engineers, IEICE Technical Report, Vol. 116, No. 398, January 2017, pp. 33-38) can be used.

Next, the functions of the filter device 1 configured in this way will be explained using FIG. 2 or the like. When the engine of the work machine is operated, hydraulic oil flows into the space S1 inside the case 10. The hydraulic oil flowing from the space S1 into the space S2 flows from the outside to the inside of the filtration member 21, and the filtration member 21 removes dust or the like from the hydraulic oil. The hydraulic oil after being filtered flows out into the space S3. The hydraulic oil after being filtered then flows out of the outflow portion 33.

Once the case 10 is filled with the hydraulic oil, the differential pressure detection unit 60 of the measurement unit 40 detects differential pressure between pressure upstream of the filtration member 21 (space S2) and pressure downstream of the filtration member 21 (space S3). The detection unit 61 detects changes in the magnetic field caused by the movement of the magnet 63 and transmits the detection results to the external device. When the detection result shows that the differential pressure between the space S2 and the space S3 is a predetermined level or more, that is, the clogging of the filtration member 21 exceeds a predetermined amount, the external device displays a prompt to replace the filter element 20.

Since the clogging of the filtration member 21 is substantially proportional to the operating time of the filter element 20, the operating time of the filter element 20 is measured by the IC tag 51, this IC tag 51 is read by the antenna 52 wirelessly, and this reading result is transmitted from the measurement unit 40 to the external device. The clogging of the filtration member 21 is substantially proportional to the operating time of the filter element 20, but the filtration member varies depending on the type of filter. Obtaining the information (serial number) of the filtration member 21 from the IC tag 51, transmitting this information and the operating time of the filtration member 21 together to the external device, and comparing life data of the filtration member 21 with the operating time allows the state of the filtration member 21 to be more appropriately determined.

By transmitting the information on the filtration member 21 among the results of reading the IC tag 51 from the measurement unit 40 to the external device, it is possible to confirm whether an incorrect product (including counterfeit product) is used in the filter device 1.

In addition, power can be transmitted wirelessly from the antenna 52 to the IC tag 51, that is, wireless power transfer is possible. The IC tag 51 may also have a built-in power supply (not illustrated), in which the antenna 52 can only perform wireless communication with the IC tag 51.

According to the present embodiment, by arranging the IC tag 51 and the antenna 52 across the partition wall 12 formed of metal, and connecting the antenna coil 51a of the IC tag 51 and the antenna coil 52a of the antenna 52 to the resonance circuits 51b, 54a having an SP topology, respectively, wireless transmission (including wireless power supply) can be performed across the partition wall formed of metal.

According to the present embodiment, disposing the sensor unit 70 inside the hollow portion (space S6) formed on the root side of the measurement unit 40 rather than the antenna 52 and allowing the hydraulic oil to be supplied to the space S6 via the hole 83a allows the sensor unit 70 to monitor the hydraulic oil.

According to the present embodiment, disposing a circular-shaped IC tag 51 at the plate 24 and winding the antenna coil 51a along the inner or outer circumference of the IC tag 51 can make the antenna coil 51a larger and increase the efficiency of wireless transmission. Making the IC tag 51 have a circular shape eliminates aligning the IC tag 51 with the antenna 52 and can avoid mechanical restrictions (e.g., mounting orientation and position) of the filter element 20.

In the present embodiment, the antenna 52 and the IC tag 51 are provided across the partition wall 12, but the IC tag 51 and the antenna 52 is preferably provided adjacent to the partition wall 12.

The embodiments of the present invention have been described in detail with reference to the drawings. However, the specific configuration is not limited to these embodiments, but also includes design changes or the like to the extent that they do not depart from the gist of this invention. For example, in the examples described above, detailed description is made to facilitate understanding of the present invention, and the examples are not necessarily limited to examples including all the configurations described above. In addition, the configuration of an embodiment can be replaced partially with the configurations of other embodiments. Moreover, addition, deletion, replacement, or the like of other configurations can be made on the configurations of the embodiments.

The term “substantially” refers not only to cases where there is an exact match, but also to concepts that include errors and modifications to an extent that does not lose their identity. For example, the term “cylindrical shape” refers not only to strictly cylindrical shape, but also to concepts that include cases where the shape can be considered to be the same as a cylindrical shape. For example, when expressions such as simply orthogonal, parallel, and coincident are used, such expressions include not only strictly orthogonal, parallel, and coincident but also substantially parallel, substantially orthogonal, and substantially coincident.

The term “near” means that it includes a certain range (which can be determined as desired) of area near the reference position. For example, the term “near an end” refers to a range of regions near the end, and is a concept indicating that the end may or need not be included.

### REFERENCE SIGNS LIST

1: Filter device
10: Case
11: Case body
11a: Bottom surface
11b: Side surface
12: Partition wall
12a: Tubular portion
12b: Hole
13: Attachment portion
15: Elastic member
19: Filter case
20: Filter element
21: Filtration member
22: Inner tube
23: Outer tube
24: Plate
25: Plate
30: Head
31: Tubular portion
31a: Hollow portion
32: Outer peripheral portion
33: Outflow portion
34: Bore
35: Hole
39: Bypass valve
40: Measurement unit
50: Wireless transmission unit
51: IC tag
51a: Antenna coil
51b: Resonance circuit
52: Antenna
52a: Antenna coil
53: Antenna line
54: Substrate
54a: Resonance circuit
60: Differential pressure detection unit
61: Detection unit
61a: Magnetic field detection element
62: Spool
63: Magnet
64: Elastic member
70: Sensor unit
71: Temperature sensor
72: Viscosity sensor
80: Housing
81: Case
81a, 81b, 81e: Bore
81c, 81d: Hole
81v, 81w: Columnar portion
82, 83: Cover
83a: Hole
84: Insertion member
91, 92, 96 to 99: Sealing member

1. A filter device, comprising:
a filter element comprising a filtration member configured to filter a liquid and an IC tag comprising a first antenna coil;
a filter case provided with the filter element inside the filter case; and
a measurement unit disposed in the filter case and comprising an antenna comprising a second antenna coil, wherein
the filter device performs transmission by magnetic resonance coupling between the first antenna coil and the second antenna coil,
the filter case comprises a partition wall that partitions an internal space into a first region provided with the filter element and a second region not provided with the filter element and is made of metal,
the measurement unit comprises a housing attached to the filter case,
the housing is disposed in the filter case,
a tip end of the housing is inserted in the second region, and
the antenna and the IC tag are positioned across the partition wall.

2. The filter device according to claim 1, comprising
a wireless transmission unit comprising the IC tag and the antenna, wherein
the wireless transmission unit comprises a first resonance circuit connected to the IC tag and a second resonance circuit connected to the antenna,
the first resonance circuit and the second resonance circuit are each a resonance circuit having an SP topology.

3. The filter device according to claim 1, wherein
the measurement unit comprises a sensor configured to measure viscosity or temperature of the liquid,
the housing comprises an insert portion to be inserted into the filter case or the second region,
the antenna is disposed near a tip end of the insert portion,
the sensor is disposed inside a hollow portion formed in the insert portion, and
the housing is provided with a communication hole through which the hollow portion communicates with a space outside the housing.

4. The filter device according to claim 1, wherein
the filter element comprises an upper plate that covers an upper end surface of the filtration member,
the IC tag has an annular shape and is disposed at the upper plate, and
the first antenna coil is wound along an inner peripheral surface or an outer peripheral surface of the IC tag.

5. The filter device according to claim 3, wherein
the measurement unit further comprises a differential pressure detection unit configured to detect differential pressure between pressure upstream of the filtration member and pressure downstream of the filtration member.

6. The filter device according to claim 2, wherein
the measurement unit comprises a sensor configured to measure viscosity or temperature of the liquid,
the housing comprises an insert portion to be inserted into the filter case or the second region,
the antenna is disposed near a tip end of the insert portion,
the sensor is disposed inside a hollow portion formed in the insert portion, and
the housing is provided with a communication hole through which the hollow portion communicates with a space outside the housing.

7. The filter device according to claim 2, wherein
the filter element comprises an upper plate that covers an upper end surface of the filtration member,
the IC tag has an annular shape and is disposed at the upper plate, and
the first antenna coil is wound along an inner peripheral surface or an outer peripheral surface of the IC tag.

8. The filter device according to claim 6, wherein
the measurement unit further comprises a differential pressure detection unit configured to detect differential pressure between pressure upstream of the filtration member and pressure downstream of the filtration member.
